(19) United States
(12) Patent Application Publication
(10) Pub. No.: US 2025/0279685 A1
(43) Pub. Date: Sep. 4, 2025

(54) MOTOR MODULE AND LIDAR

(71) Applicant: Suteng Innovation Technology Co., Ltd., Shenzhen (CN)

(72) Inventors: Gang Yang, Shenzhen (CN); Hongju Li, Shenzhen (CN)

(73) Assignee: SUTENG INNOVATION TECHNOLOGY CO., LTD., Shenzhen (CN)

(21) Appl. No.: 18/971,797

(22) Filed: Dec. 6, 2024

(30) Foreign Application Priority Data
Mar. 4, 2024 (CN) 202410247160.X

(51) Int. Cl. H02K 1/28; G01S 7/481; H02K 1/18; H02K 3/46

(52) U.S. Cl. CPC H02K 1/28; G01S 7/4813; G01S 7/4817; H02K 1/18; H02K 3/46

(57) ABSTRACT

A motor module includes a stator, a rotor, a rotor bracket and an electromagnetic assembly. The stator is provided with a first mounting hole extending in a preset direction. The rotor includes a rotating shaft and a flange portion, the rotating shaft extends into the first mounting hole, and is rotatable connected to the stator through a bearing, the rotating shaft includes a third end and a fourth end opposite to each other in a preset direction, and the third end extends out of the first mounting hole; the flange portion is formed by extending outward from the outer wall of the third end along a plane perpendicular to the preset direction.

### CROSS-REFERENCE TO RELATED APPLICATION

The present application claims the benefit of priority to Chinese Patent Application No. 202410247160.X, filed on Mar. 4, 2024, which is hereby incorporated by reference in its entirety.

### TECHNICAL FIELD

The present application relates to the field of laser detection technology, and in particular to a motor module and a LiDAR.

### BACKGROUND

LiDAR is a radar system that emits laser beams to detect position, speed and other characteristic quantities of a target. Its working principle is to first emit detection light to the target, and then receive the echo light reflected from the target. After appropriate processing, relevant information about the target can be obtained, such as target distance, direction, altitude, speed, attitude, and even shape parameters.

Generally, a LiDAR includes a housing, a motor module and a transceiver module. The housing is the mounting base for the remaining structures in the LiDAR. The motor module is housed in the housing, and includes a stator, a rotor and an electromagnetic assembly. The stator is fixed to the housing. The rotor includes a rotating shaft and a rotor bracket, the rotating shaft is rotatably connected to the stator, and the rotor bracket is connected to one end of the rotating shaft. The transceiver module is configured to realize the transmission and reception of laser beams, which is installed on the rotor bracket to rotate synchronously with the rotor, thereby realizing the scanning of the external environment. The electromagnetic assembly includes a winding installed on the stator and a magnet installed on the rotor, and the two are configured to cooperate to drive the rotor to rotate relative to the stator.

### SUMMARY

In an example, the rotating shaft and the rotor bracket of the rotor of the motor module in the LiDAR are integrally formed. The rotor bracket is connected to the end of the rotating shaft away from the fixed end of the stator. After the rotor bracket extends outward from the side wall of the rotating shaft for a certain distance, it extends to the side close to the fixed end of the stator, so as to provide space for installing components such as circuit boards and facilitate the installation of magnets on the one hand, and to appropriately compress the height of the motor module on the other hand. However, this structure of the rotor makes it possible for the rotating shaft to only ensure its side accuracy through lathe processing, and hard to be fine-machined by a grinder with higher processing accuracy, because the structure of the rotor bracket in the rotor will interfere with the grinding of the rotating shaft. Therefore, the processing accuracy of the rotating shaft is low, and there may be defects when it is installed with the stator.

Embodiments of the present application provide a motor module and a LiDAR to improve the current situation where the machining accuracy of the rotating shaft is low.

In a first aspect, an embodiment of the present application provides a motor module, which includes a stator, a rotor, a rotor bracket and an electromagnetic assembly. The stator is provided with a first mounting hole extending in a preset direction. The rotor includes a rotating shaft and a flange portion, the rotating shaft extends into the first mounting hole, and is rotatable connected to the stator through a bearing, the rotating shaft includes a third end and a fourth end opposite to each other in the preset direction, the third end extends out of the first mounting hole, and the flange portion is formed by extending outward from the outer wall of the third end along a plane perpendicular to the preset direction. The rotor bracket is mounted on the flange portion and is arranged around the rotating shaft. The electromagnetic assembly includes a winding and a magnet, one of the winding and the magnet is mounted on the stator, and the other is mounted on the rotor bracket.

In some embodiments, the stator includes a cylinder and a mounting plate. The cylinder extends along the preset direction and includes a first end and a second end extending along the preset direction, and the cylinder is provided with the first mounting hole penetrating along the preset direction. The mounting plate is formed by extending outward from the outer wall of the first end; the third end extends out of the first mounting hole from the second end.

In some embodiments, the mounting plate is provided with a second mounting hole, the second mounting hole is used to fix the stator, there is a first distance between the axis of the second mounting hole and the axis of the first mounting hole, and the ratio of the first distance to the radius of the first mounting hole is greater than 2.

In some embodiments, the motor module includes two bearings, which are spaced apart in the first mounting hole. The motor module also includes a sleeve, which is arranged between the two bearings and abuts against end surfaces of the two bearings respectively.

In some embodiments, the rotor bracket includes a first connecting portion and a first mounting portion. The first connection portion is fixed to a side of the flange portion facing the fourth end, and the first mounting portion is connected to a side of the first connecting portion facing the fourth end.

In some embodiments, the first mounting portion has a first surface and a second surface that are opposite to each other along the preset direction. Along the preset direction, the first surface is a surface away from the fourth end, and the second surface is a surface close to the fourth end.

In some embodiments, the rotor bracket further includes a second mounting portion, the second mounting portion extending from the second surface along the preset direction away from the first surface and arranged around the cylinder. One of the winding and the magnet is sleeved on the outer wall of the cylinder, and the other is mounted on the inner wall of the second mounting portion.

In some embodiments, the flange portion is provided with a plurality of first grooves, the first grooves extending from the edge of the flange portion to the center of the flange portion, the first grooves being arranged in an array around the axis of the rotating shaft, and a first fixing portion being formed between two adjacent first grooves. The first connecting portion is provided with a second fixing portion on a side of the first fixing portion close to the fourth end, the first connecting portion has a second groove between two adjacent fixing portions, and the second fixing portion is fixedly connected to the first fixing portion. The first groove is used for the second fixing portion to pass through, and the second groove is used for the first fixing portion to pass through.

In some embodiments, the motor module further includes a magnetic ring assembly and a magnetic ring plate assembly. The magnetic ring assembly includes a first magnetic ring and a second magnetic ring, wherein the first magnetic ring is mounted on a side of the mounting plate facing the rotor bracket, and the second magnetic ring is arranged on a side of the rotor bracket facing the mounting plate and is arranged opposite to the first magnetic ring. The magnetic ring plate assembly includes a first magnetic ring plate and a second magnetic ring plate, wherein the first magnetic ring plate is used to supply power to the first magnetic ring, the second magnetic ring plate is fixed to the second surface of the first mounting portion, and the second magnetic ring plate is used to receive the current derived from the second magnetic ring.

In an embodiment, a LiDAR is provided, which includes a housing, the motor module and a transceiver module. The housing is provided with an accommodation cavity. The motor module is accommodated in the accommodation cavity. The transceiver module is mounted on the motor module, and is used to emit detection light and receive echo light, wherein the detection light is used to detect a target object, and the echo light is formed by the target object reflecting the detection light.

In an embodiment, a LiDAR is provided, which includes a housing, the motor module, a transceiver module and a circuit board. The housing is provided with an accommodation cavity. The motor module is accommodated in the accommodation cavity. The transceiver module is mounted on the motor module, and is used to emit detection light and receive echo light, wherein the detection light is used to detect a target object, and the echo light is formed by the target object reflecting the detection light. The circuit board is mounted on the first mounting portion.

In some embodiments, the LiDAR includes a dynamic balance adjustment module, and the dynamic balance adjustment module includes an adjustment block and an adjustment column. The adjustment block and the adjustment column are installed on the transceiver module, and the adjustment block and the adjustment column are used to counterweight the transceiver module together to achieve static balance when the motor module is running. The adjustment column is used to counterweight the transceiver module to achieve dynamic balance when the motor module is running. The adjustment column includes a rod body extending along the preset direction, and the rod body is partially expanded to form an annular portion arranged around the rod body.

Motor module provided in an embodiment includes a stator, a rotor, a rotor bracket and an electromagnetic assembly. The stator is provided with a first mounting hole extending in a preset direction. The rotor includes a rotating shaft extending into the first mounting hole and a flange portion extending outward from the third end of the rotating shaft along a plane perpendicular to the preset direction. The rotor bracket is mounted on the flange portion for mounting the above-mentioned transceiver module. One of the winding and the magnet of the electromagnetic assembly is mounted on the stator, and the other is mounted on the rotor bracket.

The flange of the rotor in the motor module provided in an embodiment is a plate-shaped structure perpendicular to the rotating shaft, so the rotating shaft can be fine-machined with a higher-precision grinder to reduce the machining tolerance of the rotating shaft and improve the surface accuracy of the rotating shaft. Therefore, the motor module provided in an embodiment can improve the current status of low machining accuracy of the rotating shaft.

The bearings in the motor module are mounted through the sleeve. Since the end face of the sleeve can be processed by a grinder with higher processing accuracy, the parallelism of the two bearings can be improved. In this way, the coaxially of the two bearings can be guaranteed by improving the processing accuracy of the shaft, and the parallelism of the two bearings can be guaranteed by the processing accuracy of the sleeve end face. The wear and abnormal sound during the rotation of the bearing can be alleviated, and the service life of the bearing and the reliability of the rotor during rotation can be improved.

### BRIEF DESCRIPTION OF DRAWINGS

FIG. 1 is a perspective schematic diagram of a LiDAR provided in some embodiments of the present application.

FIG. 2 is an exploded schematic diagram of the LiDAR in FIG. 1.

FIG. 3 is a schematic cross-sectional view of the LiDAR in FIG. 1.

FIG. 4 is a schematic cross-sectional view of the motor module in FIG. 2 in one direction.

FIG. 5 is a schematic diagram of a motor module provided in some embodiments of the present application.

FIG. 6 is a cross-sectional schematic diagram of a motor module in some embodiments of the present application.

### REFERENCE SIGNS

1: LiDAR;
100: housing;
110: bottom shell;
120: middle shell;
130: top shell;
101: accommodating cavity;
200: motor module;
210: stator;
220: rotor;
230: rotor bracket;
240: electromagnetic assembly;
250: bearing;
260: sleeve;
270: magnetic ring assembly;
280: magnetic ring plate assembly;
211: cylinder;
212: mounting plate;
221: rotating shaft;
222: flange portion;
231: first connecting portion;
232: first mounting portion;
233: second mounting portion;
241: winding;
242: magnet;
271: first magnetic ring;
272: second magnetic ring;
281: first magnetic ring plate;
2111: first end;
2112: second end;
2211: third end;
2212: fourth end;
2321: first surface;
2322: second surface;
2323: first sink;
2331: first sink;
201: first mounting hole;
202: second mounting hole;
300: transceiver module;
200b: motor module;
220b: rotor;
230b: rotor bracket;
221b: rotating shaft;
222b: flange portion;
231b: first connecting portion;
2225b: first groove;
2226b: first fixing portion;
2315b: second groove;
2316b: second fixing portion;
200c: motor module;
220c: rotor;
230c: rotor bracket;
235c: first bracket;
236c: second bracket.

### DETAILED DESCRIPTION

In order to make the objectives, technical solutions and advantages of the present application more clear, the embodiments of the present application will be further described in detail below with reference to the accompanying drawings.

When the following description refers to the drawings, unless otherwise indicated, the same numbers in different drawings represent the same or similar elements. The embodiments described in the following exemplary embodiments do not represent all embodiments consistent with the present application.

In an example, the rotating shaft and the rotor bracket of the rotor of the motor module in the LiDAR are integrally formed. The rotor bracket is connected to the end of the rotating shaft away from the fixed end of the stator. After the rotor bracket extends outward from the side wall of the rotating shaft for a certain distance, it extends to the side close to the fixed end of the stator, so as to provide space for installing components such as circuit boards and facilitate the installation of magnets on the one hand, and to appropriately compress the overall height of the motor module on the other hand. However, this structure of the rotor makes it possible for the rotating shaft to ensure its side accuracy only through lathe processing, and cannot be fine-machined by a grinder with higher processing accuracy, because the structure of the rotor bracket in the rotor will interfere with the grinding of the rotating shaft. That is, the current processing accuracy that can be achieved by the rotating shaft is low.

In addition, the rotor is installed in the mounting hole of the stator through two bearings; the two bearings are distributed at both ends of the mounting hole to ensure a larger bearing span. Accordingly, the stator further forms grooves at both ends of the mounting hole to install the outer ring of the bearing. However, since the two grooves need to be processed from both ends of the stator in terms of technology, that is, the stator needs to be clamped twice, which means that the parallelism of the bottom surfaces of the two grooves is difficult to ensure; generally speaking, the parallelism of the bottom surfaces of the two grooves is approximately 15 μm, so there is a risk of low parallelism of the two bearings.

Embodiments of the present application provide a motor module and a LiDAR, to improve the current situation where the machining accuracy of the rotor shaft in the motor module is relatively low.

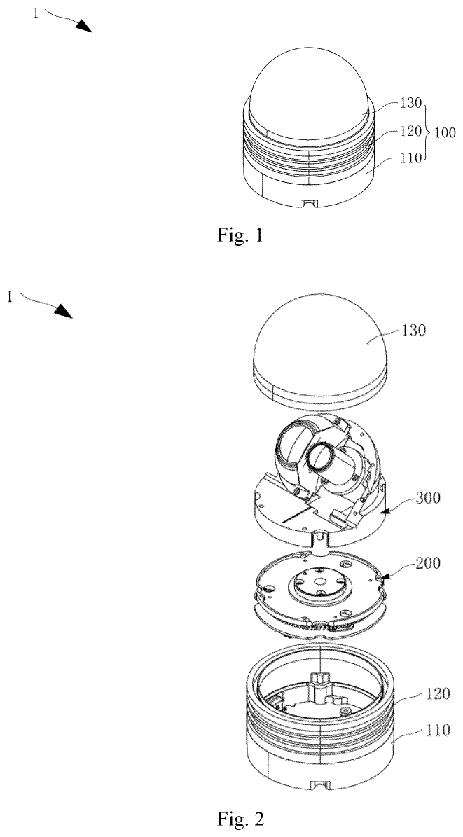

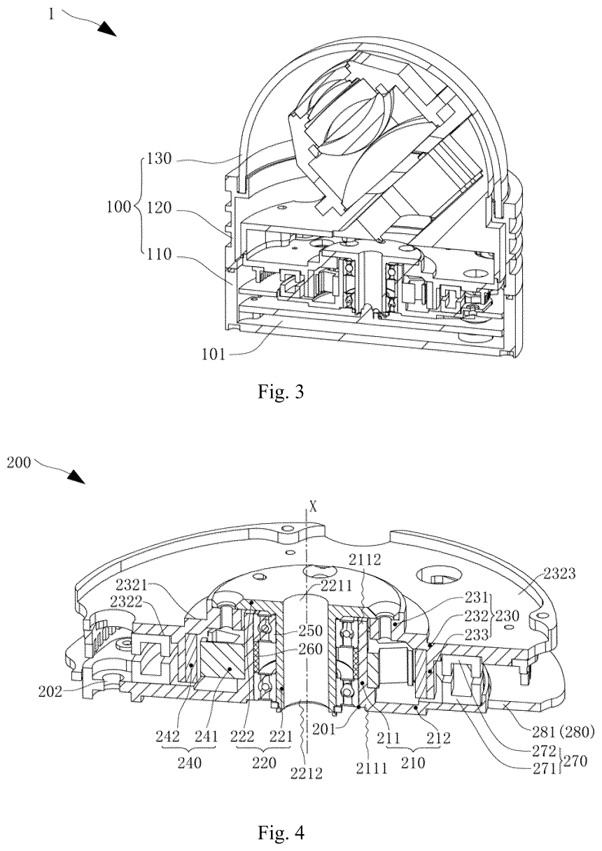

Refer to FIGS. 1 to 3, which respectively show a stereoscopic schematic diagram, an exploded schematic diagram and a cutaway schematic diagram of a LiDAR 1 provided in some embodiments of the present application. The LiDAR 1 includes a housing 100, a motor module 200 and a transceiver module 300. The housing 100 is a mounting base for the motor module 200 and the transceiver module 300, and also constitutes a protective structure for the motor module 200 and the transceiver module 300. The housing 100 defines an accommodation cavity 101. The motor module 200 is accommodated in the accommodation cavity 101. The transceiver module 300 is used to emit detection light and receive echo light, and is installed on the motor module 200; the motor module 200 is used to drive the transceiver module 300 to rotate, so that the LiDAR 1 can scan the external environment. The detection light described in the embodiment of the present application means the laser emitted outward by the LiDAR 1 and used to detect the target object, and the echo light described in the embodiment of the present application means the laser reflected by the target object and directed toward the LiDAR 1.

For the housing 100, refer to FIG. 2, it includes a bottom shell 110, a middle shell 120 and a top shell 130. The bottom shell 110, the middle shell 120 and the top shell 130 are arranged in sequence and enclose a closed accommodating cavity 101. The bottom shell 110 is a box-shaped structure, which includes a flat bottom wall and a side wall extending from the edge of the bottom wall. The middle shell 120 is an annular structure, which is arranged at one end of the side wall of the bottom shell 110 away from the bottom wall. The middle shell 120 and the bottom shell 110 are formed separately and fixed by gluing, clamping or screwing; the way in which the two are formed separately allows the motor module 200 and the transceiver module 300 to be assembled on the bottom shell 110 first, and then the middle shell 120 is assembled, which is conducive to reducing the difficulty of installing the motor module 200 and the transceiver module 300. The top shell 130 is a shell-like structure with a hemispherical surface or other curved surface, and is covered on one end of the middle shell 120 away from the bottom shell 110, so that the bottom shell 110, the middle shell 120 and the top shell 130 together define the above-mentioned closed accommodating cavity 101. The top shell 130 is made of a laser transmissivity material to allow the detection light and the echo light to pass through.

For the motor module 200, refer to FIG. 4, which shows a cross-sectional schematic diagram of the motor module 200 in FIG. 2 in one direction. The motor module 200 includes a stator 210, a rotor 220, a rotor bracket 230 and an electromagnetic assembly 240. The stator 210 is provided with a first mounting hole 201 extending along the preset direction X shown in the figure. The rotor 220 includes a rotating shaft 221 and a flange portion 222. The rotating shaft 221 extends into the first mounting hole 201 and is rotatable connected to the stator 210 through a bearing 250; the rotating shaft 221 includes a third end 2211 and a fourth end 2212 opposite to each other along the preset direction X, and the third end 2211 extends out of the first mounting hole 201. The flange portion 222 is formed by extending outward from the outer wall of the third end 2211 along a plane perpendicular to the preset direction X. The rotor bracket 230 is mounted on the flange portion 222 and is disposed around the rotating shaft 221. The electromagnetic assembly 240 includes a winding 241 and a magnet 242, one of which is mounted on the stator 210, and the other is mounted on the rotor bracket 230.

In an embodiment, referring to FIG. 4 and combining with FIG. 1 to FIG. 3, the structure of the motor module 200 is described.

For the aforementioned stator 210, refer to FIG. 4. The stator 210 is a fixed component of the motor module 200, which is fixed to the bottom shell 110. In an embodiment, the stator 210 is flange-shaped, and includes a cylinder 211 and a mounting plate 212. The cylinder 211 extends along the preset direction X shown in the figure, and includes a first end 2111 and a second end 2112 extending along the preset direction X; the first end 2111 is an end close to the bottom wall of the bottom shell 110, and the second end 2112 is an end away from the bottom wall of the bottom shell 110. The cylinder 211 is provided with a first mounting hole 201 that passes through along the preset direction X, that is, the first mounting hole 201 extends from the first end 2111 to the second end 2112. The mounting plate 212 is disposed at the first end 2111 of the cylinder 211, and extends outward from the outer wall of the first end 2111 to form a plate-like structure. The mounting plate 212 is fixed to the bottom shell 110 of the housing 100; specifically, the mounting plate 212 is provided with a plurality of second mounting holes 202 for fixing the stator 210. The second mounting holes may be distributed around the array of the first mounting holes. The mounting plate 212 may be locked to the housing 100 by passing a threaded fastener through the second mounting holes.

In an embodiment, there is a first distance between the axis of the second mounting hole 202 and the axis of the first mounting hole 201, and the ratio of the first distance to the radius of the first mounting hole 201 is greater than 2. In this way, the stator 210 has a higher installation span, thereby improving the overall rigidity of the motor module; when the motor module is impacted or vibrated, the overall deformation of the motor module is small, which is conducive to ensuring the smooth operation of the motor module 200.

For the rotor 220, please continue to refer to FIG. 4, which includes a rotating shaft 221 and a flange portion 222. The rotating shaft 221 is a cylindrical structure extending along a preset direction X to reduce the weight of the rotating shaft 221, and has a third end 2211 and a fourth end 2212 opposite to each other along the preset direction X. The third end 2211 slightly protrudes from the second end 2112 of the cylinder 211 to the first mounting hole 201, and the fourth end 2212 slightly protrudes from the first end 2111 of the cylinder 211 to the first mounting hole 201. The rotating shaft 221 is installed on the above-mentioned cylinder 211 through two bearings 250, so that the rotor 220 and the stator 210 are rotatable connected; wherein the two bearings 250 are arranged at intervals in the first mounting hole 201 to support the rotating shaft 221 to rotate smoothly. In this embodiment, the two bearings 250 are respectively located at the first end 2111 and the second end 2112 to maximize the distance between the two bearings 250. Both ends of the rotating shaft 221 extend out of the first mounting hole 201, which is conducive to installing the two bearings 250 with the maximum distance.

In an embodiment, the motor module 200 includes a sleeve 260. The sleeve 260 is received in the first mounting hole 201 and is annular in structure as a whole; the sleeve 260 is arranged around the rotating shaft 221 and is located between the two bearings 250, with one end thereof abutting against the end surface of one bearing 250 and the other end abutting against the end surface of the other bearing 250. In this way, the two end surfaces of the sleeve 260 along the preset direction X form mounting surfaces of the two bearings 250. In some embodiments of the present application, the cylinder of the stator 210 may partially extend from the inner wall toward the axis to form an inner flange portion equivalent to the sleeve 260, so as to carry and mount two bearings through the two end surfaces of the inner flange portion. Since the inner flange is integrally formed on the cylinder 211, in the machining process, it is necessary to clamp the stator 210 twice for cutting to obtain the inner flange; which means that the parallelism of the two end faces of the inner flange is poor, as mentioned above, it is approximately 15 μm, which leads to the risk of low parallelism of the two bearings. In contrast, in the embodiment of the present application, the sleeve 260 is independently arranged and embedded in the first mounting hole 201, so that the sleeve 260 can be preliminarily processed on both end faces of the sleeve 260 by a lathe during machining, and then the two end faces of the sleeve 260 are finely processed by a grinder to ensure that the two end faces of the sleeve 260 can have better parallelism, thereby improving the parallelism of the two bearings 250 during installation. As for the fixing method of the bearing 250, it can be fixed to the sleeve 260 and the stator 210 by glue dispensing, or fixed to the stator 210 by other suitable methods such as interference fit.

The flange portion 222 is a flat structure as a whole, and is located in a plane perpendicular to the preset direction X. One end of the flange portion 222 is connected to the outer wall of the third end 2211 of the rotating shaft 221, and the other end extends away from the rotating shaft 221 in a plane perpendicular to the preset direction X. This structure of the rotor 220 allows the rotating shaft 221 to be finely processed by a grinder with higher processing accuracy than a lathe to ensure the surface accuracy of the rotating shaft 221, thereby ensuring that the two bearings 250 have good coaxially; the setting of the sleeve 260 can further ensure the parallelism of the two bearings 250; in this way, the wear phenomenon and abnormal sound phenomenon occurring during the rotation of the rotor bearing 250 can be alleviated, and the service life of the bearing 250 and the reliability of the rotor 220 during the rotation process can be improved.

As for the rotor bracket 230, refer to FIG. 4. The rotor bracket 230 is installed on the flange 222. The rotor bracket 230 is used to install part of the structure in the electromagnetic assembly 240 and the transceiver module 300. The rotor bracket 230 is similar to a rotating body structure as a whole, and includes a first connecting portion 231 and a first mounting portion 232. The first connecting portion 231 is used to connect with the rotor 220, and is fixed to the side of the flange 222 facing the fourth end 2212. In this way, the height of the motor module 200 is roughly equal to the height of the rotor 220, which is conducive to reducing the overall height of the motor module 200. The first mounting portion 232 is connected to the side of the first connecting portion 231 facing the fourth end 2212, and is used to install the circuit board and the transceiver module 300. In an embodiment, the first mounting portion 232 has a first surface 2321 and a second surface 2322 that are opposite to each other along a preset direction X. Along the preset direction X, the first surface 2321 is a surface away from the fourth end 2212 of the rotor 220, and the second surface 2322 is a surface close to the fourth end 2212 of the rotor 220. The first surface 2321 is concave to form a first sink 2323 for accommodating some components on the circuit board to avoid interference between the circuit board and the rotor bracket 230.

For the electromagnetic assembly 240, refer to FIG. 4, the electromagnetic assembly 240 includes a winding 241 and a magnet 242. The winding 241 is mounted on the stator 210, and the magnet 242 is mounted on the rotor bracket 230. The winding 241 is used to generate a magnetic field by energizing, thereby driving the magnet 242 and the rotor 220 to rotate relative to the stator 210. In an embodiment, the rotor bracket 230 includes a second mounting portion 233. The second mounting portion 233 is an annular structure, which is formed by extending from the second surface 2322 of the first mounting portion 232 away from the first surface 2321 along a preset direction X, and is arranged around the cylinder 211; that is, the second mounting portion 233 and the cylinder 211 are arranged opposite to each other along the radial direction of the cylinder 211. The winding 241 is sleeved on the outer wall of the cylinder 211, and the magnet 242 is installed on the inner wall of the second mounting portion 233, so that the magnet 242 can rotate around the cylinder 211 under the action of the electromagnetic field generated by the winding 241; accordingly, the rotor 220 will also rotate relative to the cylinder 211. Of course, in other embodiments of the present application, the magnet can also be set on the stator, such as sleeved on the outer wall of the cylinder; accordingly, the winding is set on the rotor bracket, such as the inner wall of the second mounting portion.

In some embodiments, the motor module 200 includes a magnetic ring assembly 270 and a magnetic ring plate assembly 280. The magnetic ring assembly 270 includes a first magnetic ring 271 and a second magnetic ring 272. The first magnetic ring 271 is disposed on a side of the mounting plate 212 facing the rotor bracket 230, and the second magnetic ring 272 is disposed on a side of the rotor bracket 230 facing the mounting plate 212. The magnetic ring plate assembly 280 includes a first magnetic ring plate 281 and a second magnetic ring plate. The first magnetic ring plate is mounted on the housing 100 or the stator 210, and is used to supply power to the first magnetic ring 271; the second magnetic ring plate is fixed to the second surface 2322 of the first mounting portion 232, and is used to receive the current derived from the second magnetic ring and supply power to the circuit board mounted on the first mounting portion 232. In this way, the LiDAR 1 can wirelessly supply power to the circuit board installed on the rotor 220 of the motor module 200 from one side of the stator 210 of the motor module 200, so as to further supply power to the transceiver module connected to the circuit board for communication.

For the transceiver module 300, refer to FIG. 2, which includes a light source module, an emitting lens module, a receiving module and a receiving lens module. The light source module is used to generate detection light to detect the target object through the detection light. The light source module may include an emitting circuit board and a light source provided on the emitting circuit board; the circuit board installed on the rotor may be a main control circuit board, and the emitting circuit board is connected to the main control circuit board in communication. The emitting lens module is provided on the optical path of the detection light, and is used to collimate the detection light, correct aberrations and other optical processing, so that the processed detection light is emitted to the outside of the LiDAR 1 for detection. The receiving lens module is used to receive the echo light formed by the reflection of a target object, and focus the echo light, correct aberrations and other optical processing, so that the processed echo light can fall on the receiving module. The receiving module is used to receive the echo light and perform photoelectric conversion. The receiving module may include a receiving circuit board and a photoelectric detector provided on the receiving circuit board; the receiving circuit board is connected to the main control circuit board in communication.

Considering that the mass of the motor module 200 and its load (such as the transceiver module) is generally not completely symmetrical, in an embodiment, the LiDAR 1 includes a dynamic balance adjustment module, which is used to adjust the counterweight of the motor module 200 and its load so that the LiDAR 1 can achieve dynamic balance during operation. The dynamic balance adjustment module includes an adjustment block and an adjustment column. The adjustment block and the adjustment column are both installed on the transceiver module, and are used together to counterweight the transceiver module to achieve static balance. The adjustment block is a block structure, which can be set at the edge of the transceiver module to improve its ability to adjust the center of mass of the motor module 200 and the load, so that the center of mass is located on the axis of the rotating shaft. The adjustment column is a columnar structure, which includes a rod body extending along a preset direction X, and the rod body part partially expands outward to form a ring portion arranged around the rod body. In addition to having the function of adjusting static balance, the adjustment column is also used to counterweight the transceiver module to achieve dynamic balance when the motor module is running. The arrangement of the adjusting column including the rod body and the annular portion is conducive to the adjustment of dynamic balance by adjusting the annular portion of the adjusting column at different positions of the rod body during computer-aided design. In an embodiment, the motor module 200 includes two adjusting columns, which are arranged on both sides of the adjustment block to improve the adjustment efficiency of dynamic balance. After manufacturing, the rod body and the annular portion of the adjusting column can be an integrally formed rigid part, and the position of the annular portion relative to the rod body is fixed to maintain the reliability of dynamic balance during the operation of the motor module.

The working principle of the LiDAR 1 is briefly described in conjunction with the accompanying drawings.

First, the winding of the electromagnetic component 240 in the motor module 200 is energized, thereby driving the rotor 220, the rotor bracket connected to the rotor 220, and the transceiver module installed on the rotor bracket 230 to rotate.

The first magnetic ring plate 281 is powered on, and it supplies power to the main control circuit board through the first magnetic ring 271, the second magnetic ring 272, and the second magnetic ring plate. The main control circuit board controls the operation of the transmitting module and the receiving module to realize the transmission and reception of the detection light and the echo light. Since the transceiver module 300 rotates under the drive of the motor module 200, the detection light emitted by the transmitting module will scan the external environment, so that the LiDAR 1 can obtain information about the external environment.

The LiDAR 1 provided in an embodiment includes a housing 100, a motor module 200 and a transceiver module 300. The motor module 200 includes a stator 210, a rotor 220, a rotor bracket 230 and an electromagnetic assembly 240. The stator 210 is provided with a first mounting hole 201 extending along a preset direction X. The rotor 220 includes a rotating shaft 221 extending into the first mounting hole 201 and a flange portion 222 extending outward from the third end 2211 of the rotating shaft 221 along a plane perpendicular to the preset direction X. The rotor bracket 230 is installed on the flange portion 222 for installing the above-mentioned transceiver module 300. One of the winding and the magnet of the electromagnetic assembly 240 is installed on the stator 210, and the other is installed on the rotor bracket 230.

The flange portion 222 of the rotor 220 in the LiDAR 1 provided in an embodiment is a plate-shaped structure perpendicular to the rotating shaft 221, so the rotating shaft 221 can be finely processed by a grinder with higher precision to reduce the processing tolerance of the rotating shaft 221 and improve the surface precision of the rotating shaft 221. Therefore, the LiDAR 1 can improve the current status of low processing precision that can be achieved for the rotating shaft.

In addition, bearing 250 in the LiDAR 1 is installed through the sleeve 260. Since the end surface of the sleeve 260 can be processed by a grinder with higher processing accuracy, the parallelism of the two bearings 250 can be improved. In this way, the coaxially of the two bearings 250 can be guaranteed by improving the processing accuracy of the rotating shaft 221, and the parallelism of the two bearings 250 can be guaranteed by the processing accuracy of the end surface of the sleeve 260, so that the wear and abnormal sound phenomenon occurring during the rotation of the bearing 250 can be alleviated, and the service life of the bearing 250 and the reliability of the rotor 220 during the rotation process can be improved.

The structure of the motor module 200 is diverse. As long as the rotor 220 in the motor module 200 includes a rotating shaft 221 and a flange portion extending vertically from the third end of the rotating shaft 221.

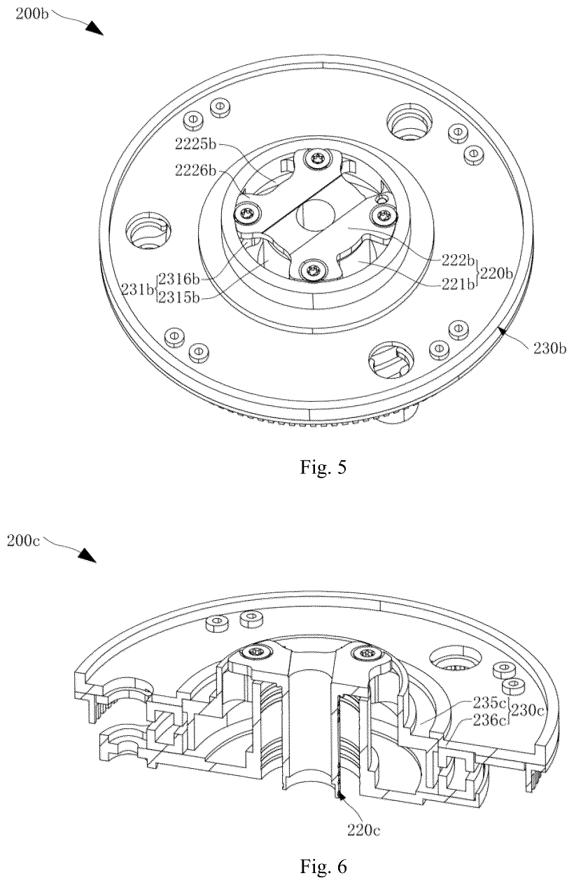

For example, refer to FIG. 5, which shows a schematic diagram of a motor module 200b provided in some embodiments of the present application, wherein the motor module 200b still includes a stator, a rotor 220b, a rotor bracket 230b and an electromagnetic assembly; wherein the rotor 220b includes a rotating shaft 221b and a flange portion 222b. The motor module 200b is mainly different from the above motor module 200 in that: the flange portion 222b is provided with a plurality of first grooves 2225b, and a first fixing portion 2226b is formed between two adjacent first grooves 2225b; the first connecting portion 231b is provided with a plurality of second grooves 2315b, and a second fixing portion 2316b is formed between two adjacent second grooves 2315b, and the second fixing portion 2316b corresponds to the first fixing portion 2226b one by one, and the second fixing portion 2316b is fixed to the first fixing portion 2226b.

The flange portion 222b is provided with a plurality of first grooves 2225b extending from the edge of the flange portion 222b to the center of the flange portion 222b, and a first fixing portion 2226b is formed between two adjacent first grooves 2225b. In this embodiment, each first groove 2225b is distributed in an array around the axis of the rotating shaft 221b, and correspondingly, each first fixing portion 2226b is also distributed in an array around the axis of the rotating shaft 221b. The first connecting portion 231b is provided with a second fixing portion 2316b on one side of the first fixing portion 2226b close to the fourth end, and the first connecting portion 231b has a second groove 2315b between two adjacent second fixing portions 2316b, and the second fixing portion 2316b is fixedly connected to the first fixing portion 2226b. The cross section of the first groove 2225b is larger than that of the second fixing portion 2316b so that the second connecting portion 2316b can pass through; the cross section profile of the second groove 2315b is larger than that of the first fixing portion 2226b so that the first connecting portion 2226b can pass through. When assembling the rotor bracket 230b, the second fixing portion 2316b can be aligned with the first groove 2225b, and the first fixing portion 2226b can be aligned with the second groove 2315b so that the second fixing portion 2316b can pass under the flange portion 222b; then, the first connecting portion 231b is rotated so that the matching portion of the second fixing portion 2316b is aligned with the first fixing portion 2226b; then, the first fixing portion 2226b and the second fixing portion 2316b are locked by a threaded fastener to complete the installation of the rotor bracket 230b.

In an embodiment, refer to FIG. 6, which shows a cross-sectional schematic diagram of a motor module 200c, which is mainly different from the motor module 200b in an embodiment shown in FIG. 5 in that the rotor bracket 230c in the motor module 200c includes a first bracket 235c and a second bracket 236c. The first bracket 235c is installed on the flange portion of the rotor 220c and is arranged around the rotor 220c; the first bracket 235c is intended to be used to achieve connection with the rotor 220c and to install the magnet of the electromagnetic component. The second bracket 236c is installed on the first bracket 235c and is arranged around the first bracket 235c; the second bracket 236c is intended to be used to install the above-mentioned main control circuit board and the transceiver module 300.

Embodiment of the present application provides a motor module, which is the motor module in the LiDAR in any of the above embodiments. The motor module can improve the current situation that the machining accuracy of the rotating shaft of the rotor in the motor module is low.

The terms “first”, “second”, etc. are used for descriptive purposes only and should not be understood as indicating or implying relative importance. “multiple” refers to at least two, for example, two, three, four, etc. “And/or” describes the association relationship of associated objects, indicating that three relationships may exist, for example, A and/or B can represent: A exists alone, A and B exist at the same time, and B exists alone. The character “I” generally indicates that the objects associated before and after are in an “or” relationship.

What is claimed is:

1. A motor module, comprising:
a stator, with a first mounting hole extending along a preset direction;
a rotor, comprising a rotating shaft and a flange portion, wherein the rotating shaft extends into the first mounting hole, and the rotating shaft is rotatably connected to the stator via a bearing, wherein the rotating shaft comprises a third end and a fourth end opposite to each other along the preset direction, wherein the third end extends out of the first mounting hole, and wherein the flange portion is formed by extending outward from an outer wall of the third end along a plane perpendicular to the preset direction;
a rotor bracket, mounted on the flange portion and is arranged around the rotating shaft; and
an electromagnetic assembly, comprising a winding and a magnet, wherein one of the winding and the magnet is mounted on the stator, and the other is mounted on the rotor bracket.

2. The motor module according to claim 1,
wherein the stator comprises a cylinder and a mounting plate;
wherein the cylinder extends along the preset direction and includes a first end and a second end extending along the preset direction, and the cylinder is provided with the first mounting hole penetrating along the preset direction;
wherein the mounting plate is formed by extending outward from an outer wall of the first end;
wherein the third end extends out of the first mounting hole from the second end.

3. The motor module according to claim 2,
wherein the mounting plate is provided with a second mounting hole, and the second mounting hole is used to fix the stator;
wherein a first distance is between an axis of the second mounting hole and an axis of the first mounting hole, and the ratio of the first distance to the radius of the first mounting hole is greater than 2.

4. The motor module according to claim 1,
wherein the motor module comprises two bearings, and the two bearings are spaced apart in the first mounting hole;
wherein the motor module includes a sleeve, which is arranged between the two bearings and abuts against one end surface of each bearing respectively.

5. The motor module according to claim 2,
wherein the rotor bracket comprises a first connecting portion and a first mounting portion;
wherein the first connecting portion is fixed to a side of the flange portion facing the fourth end, and the first mounting portion is connected to a side of the first connection portion facing the fourth end.

6. The motor module according to claim 5, wherein the first mounting portion has a first surface and a second surface opposite to each other along the preset direction, and along the preset direction, the first surface is a surface away from the fourth end, and the second surface is a surface close to the fourth end.

7. The motor module according to claim 6, wherein
the rotor bracket further comprises a second mounting portion, the second mounting portion is formed by extending from the second surface along the preset direction away from the first surface and is arranged around the cylinder; and
one of the winding and the magnet is sleeved on the outer wall of the cylinder, and the other is mounted on an inner wall of the second mounting portion.

8. The motor module according to claim 5, wherein
the flange portion is provided with a plurality of first grooves, the first grooves extending from an edge of the flange portion to a center of the flange portion, the first grooves being distributed in an array around an axis of the rotating shaft, and a first fixing portion being formed between two adjacent first grooves;
the first connecting portion is provided with a second fixing portion on one side of the first fixing portion close to the fourth end, the first connecting portion has a second groove between two adjacent fixing portions, and the second fixing portion is fixedly connected to the first fixing portion; and
the first groove is used for the second fixing portion to pass through, and the second groove is used for the first fixing portion to pass through.

9. The motor module according to claim 6, further comprising:
a magnetic ring assembly, comprising a first magnetic ring and a second magnetic ring, wherein the first magnetic ring is arranged on a side of the mounting plate facing the rotor bracket, and the second magnetic ring is arranged on a side of the rotor bracket facing the mounting plate and is arranged opposite to the first magnetic ring; and
a magnetic ring plate assembly, comprising a first magnetic ring plate and a second magnetic ring plate, wherein the first magnetic ring plate is used to supply power to the first magnetic ring, the second magnetic ring plate is fixed to the second surface of the first mounting portion, and the second magnetic ring plate is used to receive the current derived from the second magnetic ring.

10. A LIDAR, comprising:
a housing, with an accommodation cavity;
the motor module according to claim 1, housed in the accommodation cavity; and
a transceiver module, mounted on the motor module and used to emit a detection light and receive an echo light, wherein the detection light is used to detect a target object, and the echo light is formed by the target object reflecting the detection light.

11. A LIDAR, comprising:
a housing, with an accommodation cavity;
the motor module according to claim 5, housed in the accommodation cavity;
a transceiver module, mounted on the motor module, and used to emit a detection light and receive an echo light, wherein the detection light is used to detect a target object, and the echo light is formed by the target object reflecting the detection light; and
a circuit board, on the first mounting portion.

12. The LiDAR according to claim 11, further comprising a dynamic balance adjustment module, wherein the dynamic balance adjustment module comprises an adjustment block and an adjustment column;
wherein the adjustment block and the adjustment column are installed on the transceiver module, the adjustment block and the adjustment column are used to jointly counterweight the transceiver module to achieve static balance when the motor module is in operation, the adjustment column is used to counterweight the transceiver module to achieve dynamic balance when the motor module is in operation, the adjustment column comprises a rod body portion extending along the preset direction, and the rod body portion is partially expanded to form an annular portion arranged around the rod body portion.
